(19) United States
(12) Patent Application Publication
(10) Pub. No.: US 2011/0182298 A1
(43) Pub. Date: Jul. 28, 2011

(54) COMMUNICATION APPARATUS, MEDIUM AND COMMUNICATION METHOD

(76) Inventors: Yoshihiko Shimizu, Kawasaki (JP); Kei Takahata, Kawasaki (JP); Shigekazu Hagimura, Kawasaki (JP); Keizou Ueno, Kawasaki (JP); Naoyuki Hoshiba, Kawasaki (JP)

(21) Appl. No.: 13/084,089

(22) Filed: Apr. 11, 2011

Related U.S. Application Data
(63) Continuation of application No. PCT/JP2009/067705, filed on Oct. 13, 2009.

(30) Foreign Application Priority Data
Oct. 17, 2008 (JP) 2008-268128

(51) Int. Cl. H04L 12/56

(52) U.S. Cl. 370/401

(57) ABSTRACT

A communication apparatus that can communicate with a network includes a transmitting/receiving unit configured to transmit and receive a packet, a first information storing unit configured to store first information about a route, a second information storing unit configured to store second information that specifies a gateway, via which a transmitted packet is to pass, from among the first information, a detecting unit configured to detect third information including Layer 2 information about a gateway based on a received packet, a determining unit configured to determine whether or not a first condition that is a condition for a change of the second information is satisfied based on the third information, and a changing unit configured to change the gateway specified in the second information if it is determined that the first condition is satisfied.

### CROSS-REFERENCE TO RELATED APPLICATION

This application is a continuation application of International PCT application No. PCT/JP2009/067705 which was filed on Oct. 13, 2009.

### FIELD

The present invention relates to a communication apparatus, a medium and a communication method, which communicate with a network.

### BACKGROUND

One example of a configuration of a conventional communication system is described. FIG. 11 is a block diagram illustrating one example of the configuration of the conventional communication system. This communication system includes a network 11, a server 12z, routers 13a, 13b, 13c, 13d, and a terminal 14z. The server 12z and the routers 13c, 13d are connected to the network 11. The router 13a is connected to the router 13c and the terminal 14z. The router 13b is connected to the router 13d and the terminal 14z.

The routers 13a and 13b are gateways GW1 and GW2 respectively for the terminal 14z. This communication system uses IPv6 (Internet Protocol Version 6). Moreover, this communication system implements a redundant configuration by including the two gateways GW1 and GW2.

Additionally, both of GW1 and GW2 are connected to one port (network interface) of the terminal 14z.

GW1 and GW2 periodically transmit RA1 and RA2 as RA (Router Advertisement). RA1 includes prefix information P1, default router information DR1, a MAC (Media Access Control) address MAC 1 of GW1, a router lifetime (gateway validity period) and the like. Similarly, RA2 includes prefix information P2, default router information DR2, a MAC address MAC2 of GW2, a router lifetime and the like. The gateway validity period is, for example, 30 minutes.

The terminal 14z receives RA1 and RA2 respectively from GW1 and GW2. Here, assume that the terminal 14z first receives RA1 and then receives RA2. At this time, in L3 (Layer 3, IP layer) route control, the terminal 14z sets GW1 that is a transmission source of PA1 as a priority gateway, and also sets GW2 that is a transmission source of RA2 as a non-priority gateway. Moreover, if priorities are assigned, the terminal 14z sets a gateway having higher priority than the other gateway as a priority gateway.

Additionally, the terminal 14z stores L3 route information for controlling the L3 route control. FIG. 12 illustrates tables representing one example of conventional L3 route information. The L3 route information includes a default router list, a prefix list and a routing table.

The default router list is a list including an entry of each RA transmission source gateway that is a gateway of a transmission source of received RA. Moreover, each entry of the default router list includes, as items, a gateway address of an RA transmission source gateway, and a gateway validity period that is a validity period of the RA transmission source gateway.

The prefix list is a list including an entry of each prefix obtained from RA. Moreover, each entry of the prefix list includes, as items, a prefix, a gateway address of an RA transmission source gateway, and a prefix validity period that is a validity period of the prefix.

The routing table indicates a gateway address of a gateway (priority gateway) of a selected default route among RA transmission source gateways.

When the following route switching factor F1 or F2 occurs thereafter, the terminal 14z switches the priority gateway to GW2 with route switching.

F1: Interface fault (deactivation?)

F2: Timeout of P1, DR1, P2 or DR2 (when a router lifetime expires without being updated)

Related techniques include a routing control method for quickly switching a default router of a terminal within LAN to another router device with suppression of a packet loss, and a handover method for quickly performing a handover between networks including a wireless access network of a different type.

### PRIOR ART DOCUMENTS

### Patent Documents

[Patent Document 1] Japanese Laid-open Patent Publication No. 2004-336726

[Patent Document 2] Japanese Laid-open Patent Publication No. 2005-311702

However, the above described priority gateway is a gateway that has transmitted RA arriving at the terminal 14z earlier, and has been selected regardless of a line state.

Additionally, when the above described route switching factor F1 or F2 occurs, route switching is performed after a communication between the terminal 14z and the server 12z becomes impossible. Therefore, a communication interruption occurs.

Also if GW1 suspends (does not transmit RA1 any more), time is needed until F2 occurs (P1 times out). Therefore, time is needed until the priority gateway is switched.

Since P2 from a non-priority gateway is not assigned as a route in the terminal 14z, a communication cannot be performed from GW2 to the terminal 14z.

The server 12z cannot determine which gateway provides the address to the terminal 14z, and has to manage an uncommunicative address. Therefore, the server 12z cannot properly manage the terminal.

Additionally, the terminal cannot collaborate with various types of servers, such as a DNS (Domain Name System) server or the like, used to maintain the network, in order for route switching. For example, the DNS server cannot link a domain and an IP address of a communicative terminal. Therefore, proper terminal management cannot be performed.

### SUMMARY

One embodiment of the present invention is a communication apparatus that can communicate with a network. The communication apparatus includes: a transmitting/receiving unit configured to transmit a packet to the network and to receive a packet from the network; a first information storing unit configured to store first information about a route between the transmitting/receiving unit and the network; a second information storing unit configured to store second information that specifies a gateway, via which a packet transmitted from the transmitting/receiving unit to the network is to pass, from among the first information stored in the first information storing unit; a detecting unit configured to detect third information including Layer 2 information about a gateway indicated by a received packet based on the packet received by the transmitting/receiving unit; a determining unit configured to determine whether or not a first condition that is a condition for a change of the second information is satisfied based on the third information detected by the detecting unit; and a changing unit configured to change the gateway specified in the second information stored in the second information storing unit if the determining unit determines that the first condition is satisfied.

According to the embodiment of the present invention, a gateway suitable for a situation can be used.

The object and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIG. 1 is a block diagram illustrating one example of a configuration of a communication system;

FIG. 2 is a block diagram illustrating one example of a hardware configuration of a terminal;

FIG. 3 is a block diagram illustrating one example of a software configuration of the terminal;

FIG. 4 illustrates tables representing one example of route information;

FIG. 5 is a flowchart illustrating one example of a second L3 route control process;

FIG. 6 is a flowchart illustrating one example of an RA request process;

FIG. 7 is a flowchart illustrating one example of an RA reception process;

FIG. 8 is a flowchart illustrating one example of a server collaboration process;

FIG. 9 is a flowchart illustrating one example of an L2 monitoring process;

FIG. 10 is a schematic illustrating one example of a computer system to which the present embodiment is applied;

FIG. 11 is a block diagram illustrating one example of a configuration of a conventional communication system; and

FIG. 12 illustrates tables representing one example of conventional L3 route information.

### DESCRIPTION OF EMBODIMENT

An embodiment according to the present invention is described below with reference to the drawings.

A configuration of a communication system according to one embodiment of the present invention is described below.

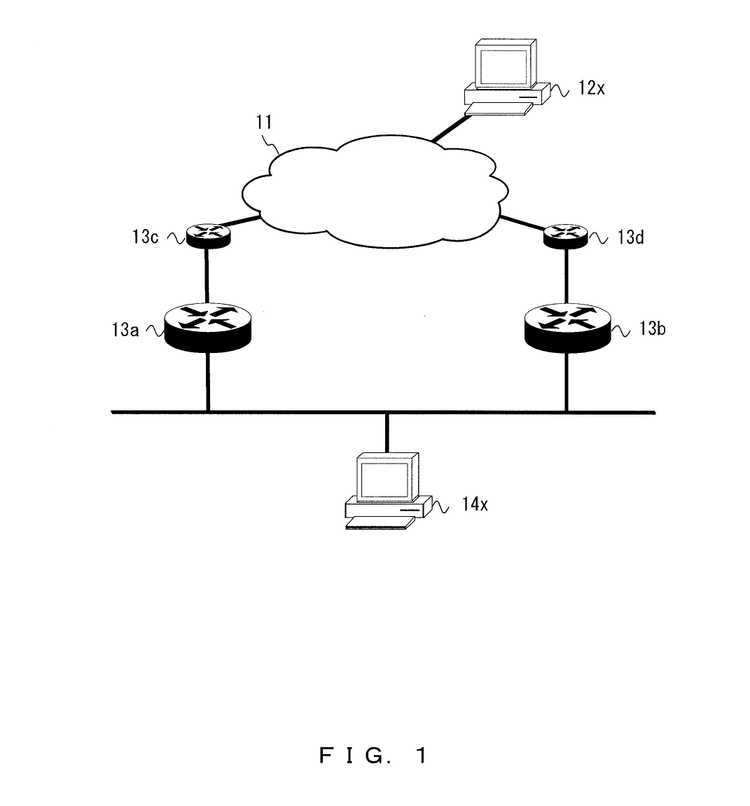

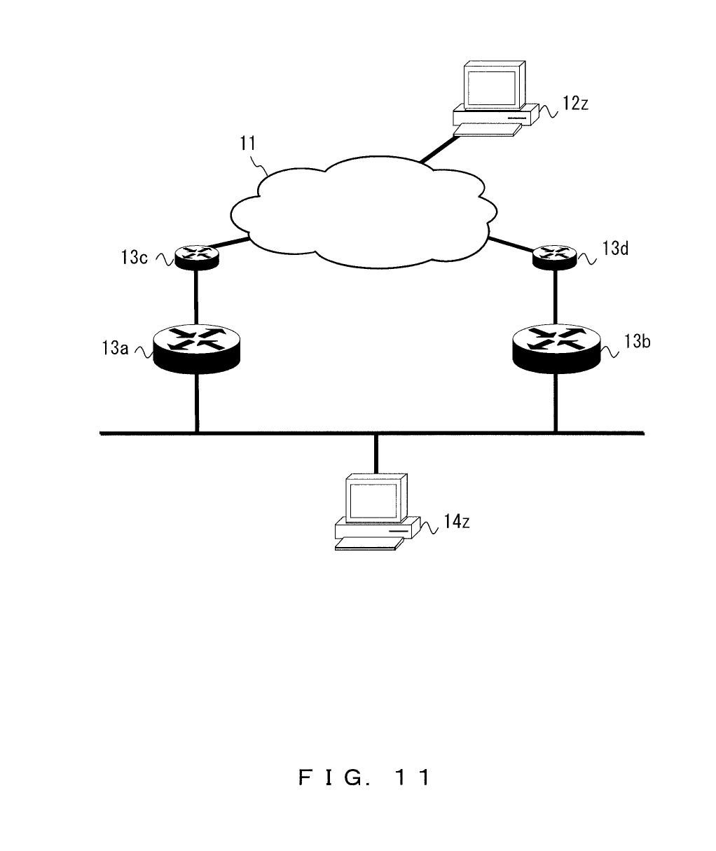

FIG. 1 is a block diagram illustrating one example of a configuration of the communication system. In this figure, the same reference numerals as those of FIG. 11 indicate components identical or equivalent to those of FIG. 11, and their explanations are omitted here. Compared with the communication system illustrated in FIG. 11, the communication system of FIG. 1 includes a server 12x as a replacement for the server 12z, and also includes a terminal 14x (communication apparatus) as a replacement for the terminal 14z. Routers 13a, 13b are gateways GW1 and GW2 for the terminal 14x. This communication system uses IPv6. Moreover, this communication system implements a redundant configuration by including the two gateways GW1, GW2.

A hardware configuration of the terminal 14x is described below.

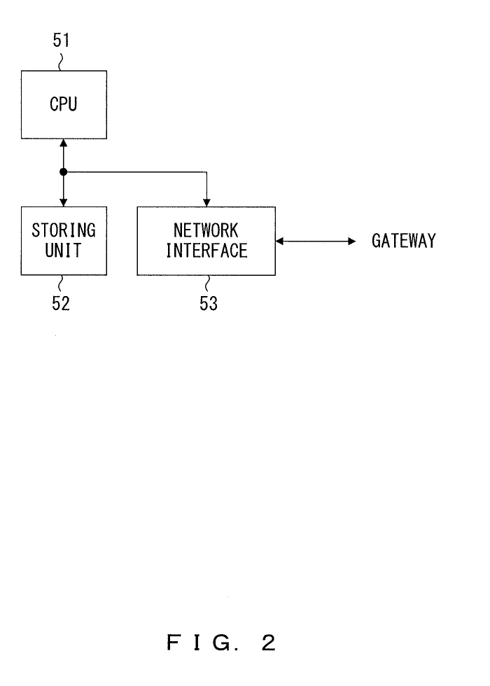

The terminal 14x is a computer that can be connected to a network. FIG. 2 is a block diagram illustrating one example of a hardware configuration of the terminal 14x. The hardware of the terminal 14x includes a CPU 51, a storing unit 52, and a network interface 53 (transmitting/receiving unit). The CPU 51 executes a communication program stored in the storing unit 52. The terminal 14x may be another network communication apparatus, such as a server, a router, a switch or the like, for performing IP routing.

The network interface 53 may be a wired or wireless port. Moreover, both of GW1 and GW2 are connected to one port (network interface 53) of the terminal 14x.

A software (communication program) configuration of the terminal 14x is described below.

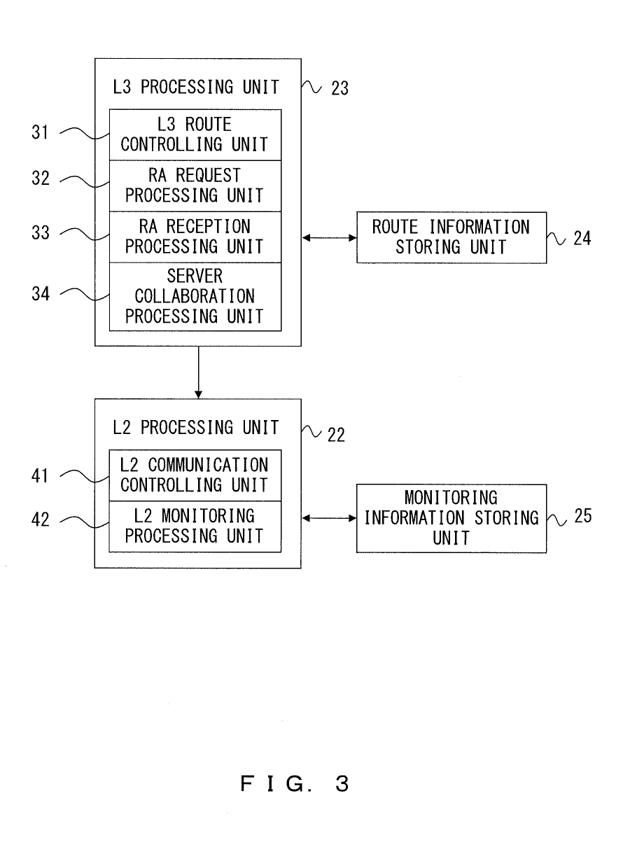

FIG. 3 is a block diagram illustrating one example of the software configuration of the terminal 14x. The software of the terminal 14x includes an L2 (Layer 2, MAC layer) processing unit 22 (a detecting unit and a determining unit), an L3 processing unit 23 (a changing unit and a setting unit), a route information storing unit 24 (a first information storing unit and a second information storing unit), and a monitoring information storing unit 25. The L3 processing unit 23 includes an L3 route controlling unit 31, an RA request processing unit 32, an RA reception processing unit 33, and a server collaboration processing unit 34. The L2 processing unit 22 includes an L2 communication controlling unit 41 and an L2 monitoring processing unit 42.

The L2 communication controlling unit 41 executes an L2 communication control process that is a control of a packet transmission/reception in L2. The L2 monitoring processing unit 42 executes an L2 monitoring process for monitoring a packet transmission/reception in L2, and transmits an L2 monitoring processing result to the L3 processing unit 23. The L2 monitoring processing result is, for example, a gateway registration instruction to register information of a gateway, a gateway switching instruction to switch (change) a priority gateway, and a gateway deletion instruction to delete information of a registered gateway. Moreover, the L2 monitoring processing result includes a MAC address of a gateway.

The L3 route controlling unit 31 executes a first L3 route control process that is a route control in L3, and a second L3 route control process that is a route control based on the L2 monitoring processing result. The RA request processing unit 32 executes an RA request process for requesting RA based on an instruction from the L3 route controlling unit 31. The RA reception processing unit 33 executes an RA reception process that is a process upon receipt of RA. The server collaboration processing unit 34 executes a server collaboration process that is a process for collaborating with the server 12x. The first L3 route control process, the second L3 route control process, the RA request process, the RA reception process and the server collaboration process are executed asynchronously.

The route information storing unit 24 stores route information for the first L3 route control process and the second L3 route control process. The monitoring information storing unit 25 stores monitoring information (third information) for the L2 monitoring process.

The route information stored in the route information storing unit 24 is described below.

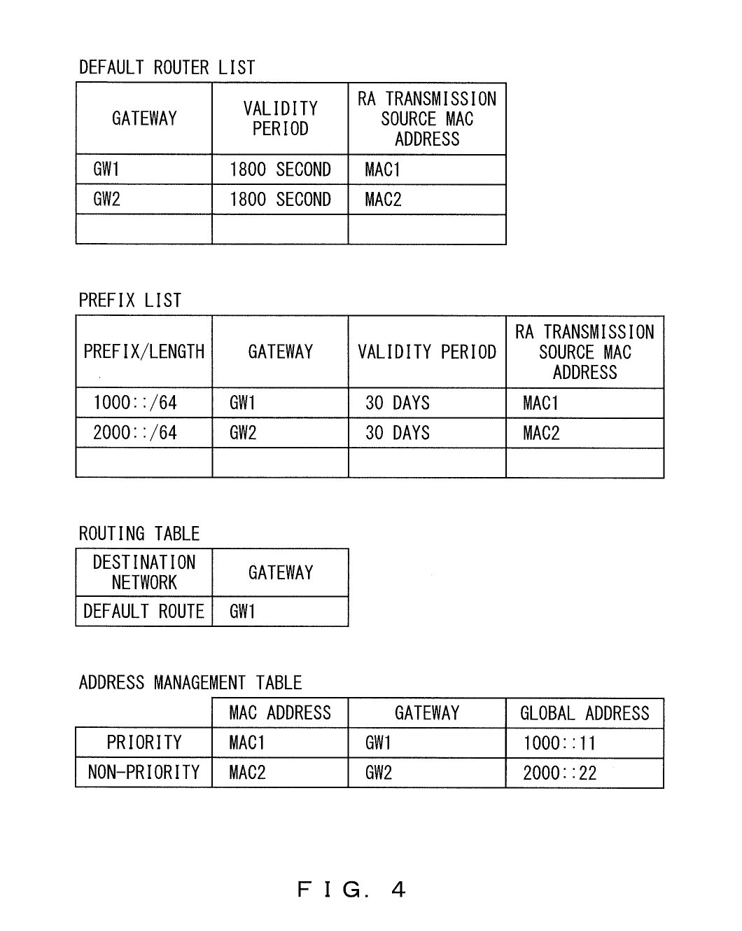

FIG. 4 illustrates tables representing one example of the route information. The route information includes a default router list, a prefix list, a routing able and an address management table. First information corresponds to the default router list, the prefix list and the address management table. The second information corresponds to the routing table.

The default router list includes, as items, a MAC address of an RA transmission source gateway in addition to the above described gateway address (IP address) and gateway validity period. The prefix list includes, as items, a MAC address of an RA transmission source gateway in addition to the above described prefix, gateway address of an RA transmission source gateway and prefix validity period. The routing table indicates a gateway address of the above described priority gateway.

The address management table is a table representing an association between a MAC address and an IP address of each RA transmission source gateway. The address management table includes, as items, a MAC address of an RA transmission source gateway, a gateway address of the RA transmission source gateway, and a global address broadcast by the RA transmission source gateway.

The default router list, the prefix list, the routing table and the address management table are associated with one another by using a gateway address. They may be associated by using another identifier as a replacement for the gateway address.

The L3 route controlling unit 31 executes the second L3 route control process concurrently with the first L3 route control process. In the first L3 route control process, the L3 route controlling unit 31 sets a priority gateway as a route in a packet transmitted from the terminal 14x to the network 11. Moreover, in the first L3 route control process, the L3 route controlling unit 31 switches the priority gateway due to the above described route switching factor F1 or F2.

The second L3 route control process executed by the L3 route controlling unit 31 is described below.

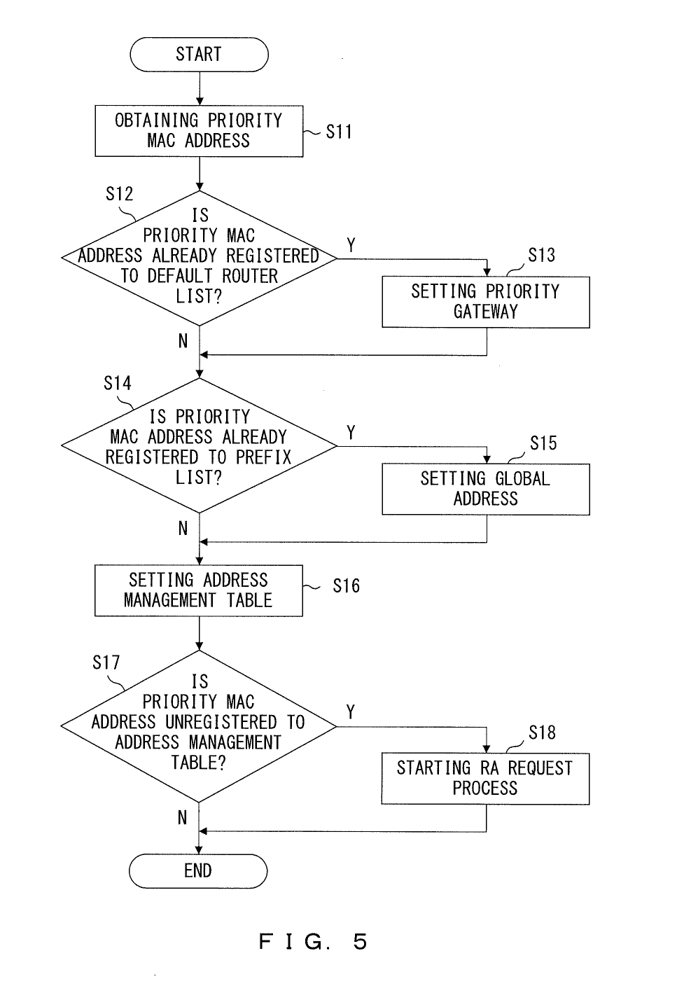

FIG. 5 is a flowchart illustrating one example of the second L3 route control process. When the L2 processing unit 22 transmits the gateway switching instruction to the L3 route controlling unit 31 as an L2 monitoring processing result, the second L3 route control process is started. The gateway switching instruction includes a priority MAC address that is a MAC address of a gateway to be set as a new priority gateway. Initially, the L3 route controlling unit 31 obtains a priority MAC address from the gateway switching instruction (S11).

Next, the L3 route controlling unit 31 determines whether or not the priority MAC address is already registered to the default router list (S12).

If the priority MAC address is already registered to the default router list (“Y” in S12), the L3 route controlling unit 31 sets the gateway corresponding to the priority MAC address as a priority gateway in the routing table and the address management table (S13). Then, this flow goes to a process in S14. The process in S13 corresponds to a process where the changing unit changes a gateway specified in the second information. If the priority MAC address is not registered to the default router list yet (“N” in S12), this flow goes to the process in S14.

Next, the L3 route controlling unit 31 determines whether or not the priority MAC address is already registered to the prefix list (S14).

If the priority MAC address is already registered to the prefix list (“Y” in S14), the L3 route controlling unit 31 sets a global address of the gateway corresponding to the priority MAC address as the priority gateway in the address management table (S14). Then, this flow goes to a process in S15. If the priority MAC address is not registered to the prefix list yet (“N” in S14), this flow goes to a process in S16.

Next, the L3 route controlling unit 31 sets the information of the gateway corresponding to the priority MAC address in the address management table (S16).

Next, the L3 route controlling unit 31 determines whether or not the priority MAC address is unregistered to the address management table (S17).

If the priority MAC address is unregistered to the address management table (“Y” in S17), the L3 route controlling unit 31 makes the RA request processing unit 32 start an RA request process that is asynchronous with the L3 route control process (S18). Then, this flow is terminated. If the priority MAC address is already registered to the address management table (“N” in S17), this flow is terminated.

The above described second L3 route control process can cope with a state change faster than the first L3 route control process by switching a priority gateway based on an L2 monitoring process result.

The RA request process executed by the RA request processing unit 32 is described below.

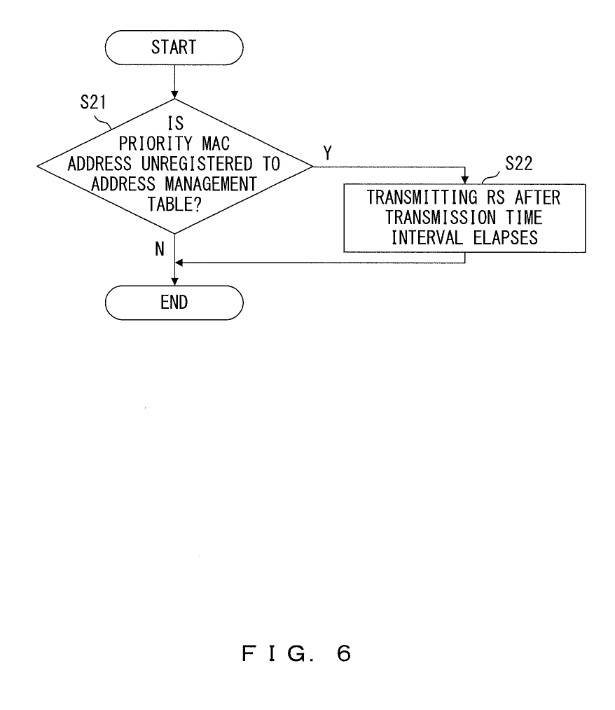

FIG. 6 is a flowchart illustrating one example of the RA request process. With the above described process in S17, the RA request process is started. Initially, the RA request processing unit 32 determines whether or not a priority MAC address is unregistered to the address management table (S21).

If the priority MAC address is unregistered to the address management table (“Y” in S21), the RA request processing unit 32 transmits RS (Router Solicitation) for requesting RA after a predetermined transmission time interval elapses (S22). Then, the flow goes back to the process in S21. Here, the transmission time interval is, for example, 4 seconds. If the priority MAC address is already registered to the address management table (“N” in S21), this flow is terminated.

With the above described RA request process, if RA is not received from a gateway to be set as a priority gateway, an RA request can be issued to the gateway.

The RA reception process executed by the RA reception processing unit 33 is described below.

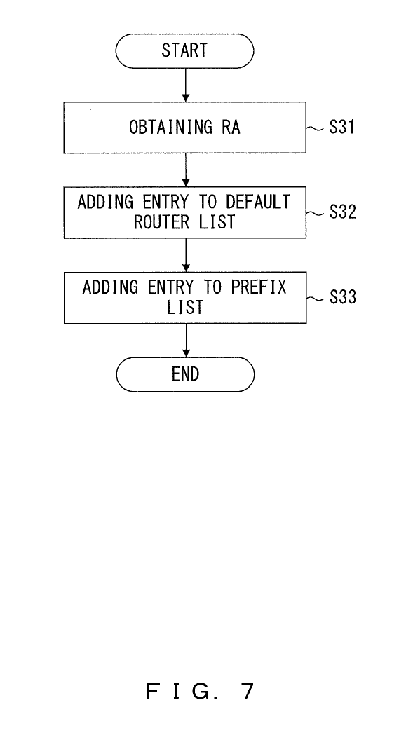

FIG. 7 is a flowchart illustrating one example of the RA reception process. When the L2 communication controlling unit 41 receives RA, the RA reception process is started. Initially, the RA reception processing unit 33 obtains RA from the L2 communication controlling unit 41 (S31). Next, the RA reception processing unit 33 adds an entry of an RA transmission source gateway (S32) to the default router list. Here, the RA reception processing unit 33 also stores a MAC address obtained from the RA in the default router list.

Next, the RA reception processing unit 33 adds an entry of the RA transmission source gateway to the prefix list (S33). Then, this flow is terminated. Here, the RA reception processing unit 33 also stores the MAC address obtained from the RA in the prefix list.

With the above described RA reception process, the L3 processing unit 23 can manage a gateway and its MAC address by associating the gateway with its MAC address.

The server collaboration process executed by the server collaboration processing unit 34 is described below.

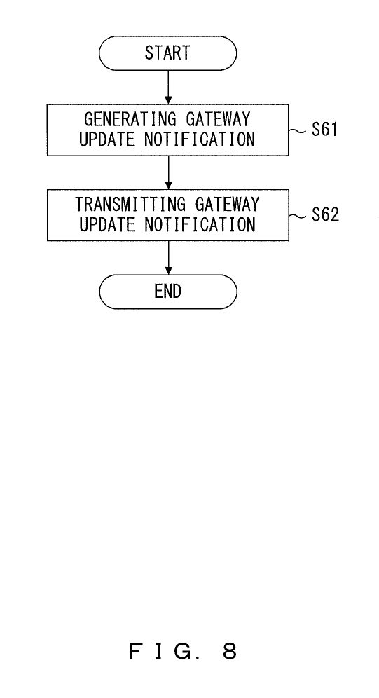

FIG. 8 is a flowchart illustrating one example of the server collaboration process. When the L3 route controlling unit 31 updates route information (including an update using the above described gateway registration instruction, gateway switching instruction or gateway deletion instruction), the server collaboration process is started. Initially, the server collaboration processing unit 34 obtains route information from the route information storing unit 24 to generate a gateway update notification (S61). The gateway update notification includes an IP address and a MAC address of a gateway updated in route information, and information indicating whether or not the gateway is a priority gateway. Here, information that can identify a gateway may be used as an alternative to the MAC address. Next, the server collaboration processing unit 34 transmits the gateway update notification to the server 12x (S62). Then, this flow is terminated.

With the above described server collaboration process, the server 12x can execute a terminal management process for managing a terminal and a route to the terminal based on the gateway update notification from the terminal 14x.

One example of the terminal management process executed by the server 12x is described below.

The server 12x has a terminal management table for managing terminals and gateways. The server 12x updates the terminal management table based on a received gateway update notification. The server 12x initially transmits a packet via a priority gateway registered in the terminal management table when transmitting the packet to the terminal 14x. Thereafter, if the server 12x unsuccessfully transmits the packet to the terminal 14x via the priority gateway, it transmits the packet to the terminal 14x via a non-priority gateway registered in the terminal management table.

The L2 monitoring process executed by the L2 processing unit 32 is described below.

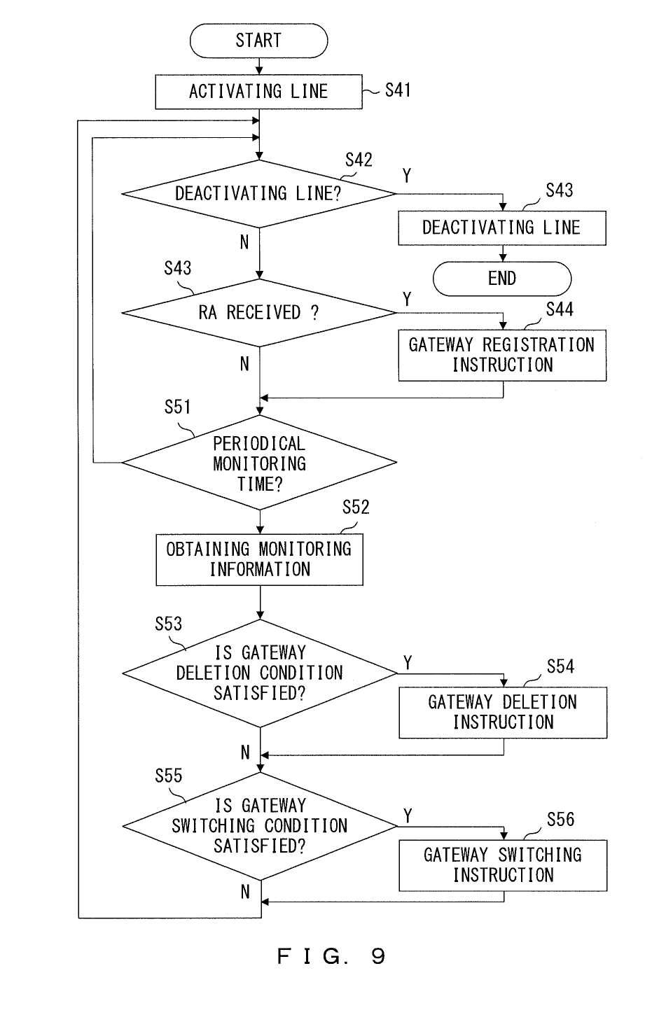

FIG. 9 is a flowchart illustrating one example of the L2 monitoring process. Upon activation of the terminal 14, the L2 communication controlling unit 41 activates a line to start receiving a packet (S41). Thereafter, the L2 monitoring processing unit 42 detects monitoring information that is information of L2 or lower layer of a gateway of the packet upon receipt of the packet, and stores the detected monitoring information in the monitoring information storing unit 25.

Next, the L2 communication controlling unit 41 determines whether or not an instruction to deactivate the line has been issued (S42). If the instruction to deactivate the line has been issued (“Y” in S42), the L2 communication controlling unit 41 deactivates the line (S43). Then, this flow is terminated. If the instruction to deactivate the line has not been issued (“N” in S42), this flow goes to a process in S44.

Next, the L2 monitoring processing unit 42 determines whether or not RA has been received (S44). If the L2 monitoring processing unit 42 has received RA (“Y” in S44), it transmits the gateway registration instruction to the L3 processing unit 23. Then, this flow goes to a process in S51. The gateway registration instruction includes a MAC address of the RA transmission source gateway. If the L2 monitoring processing unit 42 has not received RA (“N” in S44), the flow goes to the process in S51.

Next, the L2 monitoring processing unit 42 determines whether or not the time has reached a periodical monitoring time (S51). Here, the periodical monitoring time is set for each monitoring time interval. The monitoring time interval is sufficiently shorter than the above described gateway validity time, and is, for example, 10 minutes.

If the time has not reached the periodical monitoring time yet (“N” in S51), this flow goes back to the process in S42.

If the time has reached the periodical monitoring time (“Y” in S51), the L2 monitoring processing unit 42 obtains monitoring information (S52).

Next, the L2 monitoring processing unit 42 determines whether or not the gateway deletion condition (second condition) is satisfied (S53).

If the gateway deletion condition is not satisfied (“N” in S53), the flow goes to a process in S55.

If the gateway deletion condition is satisfied (“Y” in S53), the L2 monitoring processing unit 42 transmits the gateway deletion instruction to the L3 processing unit 23 (S53). Then, this flow goes to S55.

Next, the L2 monitoring processing unit 42 determines whether or not the gateway switching condition (first condition) is satisfied (S55).

If the gateway switching condition is not satisfied (“N” in S55), this flow goes back to the process in S42.

If the gateway switching condition is satisfied (“Y” in S55), the L2 monitoring processing unit 42 transmits the gateway switching instruction to the L3 processing unit 23 (S56). Then, this flow goes back to the process in S42.

The monitoring information, the gateway deletion condition and the gateway switching condition when the network interface 53 is a wired port are described below.

The monitoring information includes items such as a packet non-reception time, a packet reception flow quantity (received packet quantity), a packet reception error quantity (received error packet quantity), specified packet reception, a priority gateway MAC address and a non-priority gateway MAC address. Some of the items of the monitoring information may be omitted.

The packet non-reception time is measured for each transmission source MAC address, and this is a time during which a packet is not received from the transmission source MAC address. A packet non-reception time condition that is the gateway deletion condition for the packet non-reception time is that the packet non-reception time is longer than a predetermined expire time (time threshold value). Here, the expire time is equal to the gateway validity time, and is, for example, 30 minutes.

If the packet non-reception time condition is satisfied, this is considered as a case where a fault has occurred on a route of a corresponding gateway.

If the packet non-reception time condition is satisfied, the L2 monitoring processing unit 42 deletes the monitoring information of the gateway for which the packet non-reception time condition has been satisfied.

If the gateway deletion condition of a priority gateway is further satisfied, the gateway switching condition is satisfied. In this case, the L2 monitoring processing unit 42 transmits, to the L3 processing unit 23, the gateway switching instruction to switch to a non-priority gateway having the highest priority among non-priority gateways as a new priority gateway.

With the packet non-reception time condition, a gateway can be made unused if a packet from the gateway is not received any more.

The packet reception flow quantity is measured for each transmission source MAC address, and is the number of received packets in a monitoring time interval. A packet reception flow quantity condition that is the gateway switching condition for the packet reception flow quantity is that the packet reception flow quantity is larger than a predetermined upper limit value of the packet reception flow quantity and smaller than a predetermined lower limit value of the packet reception flow quantity.

If the packet reception flow quantity is larger than the upper limit value of the packet reception flow quantity, this is considered as a case where an error packet occurs due to degradation of line quality on a route of a corresponding gateway, or a case where attack is made via a route of a corresponding gateway. If the packet reception flow quantity is smaller than the lower limit value of the packet reception flow quantity, this is considered as a case where a fault occurs on the route of the corresponding gateway.

The packet reception error quantity is measured for each transmission source MAC address, and is an error rate of received packets in the monitoring time interval. The L2 communication controlling unit 41 checks an error of a received packet by using an error detection code such as FCS (Frame Check Sequence) or the like within the received packet. A packet reception error quantity condition that is the gateway switching condition for the packet reception flow quantity is that the packet reception error quantity is larger than a predetermined upper limit value of the packet reception error quantity. The packet reception error quantity may be the number of error packets among received packets in the monitoring time interval.

If the packet reception error quantity is larger than the upper limit value of the packet reception flow quantity, this is considered as a case where a fault occurs on a route of a corresponding gateway.

If the packet reception flow quantity condition or the packet reception error quantity is satisfied, the L2 monitoring processing unit 42 transmits, to the L3 processing unit 23, the gateway switching instruction to switch to a non-priority gateway having the highest priority among non-priority gateways as a new priority gateway.

With the packet reception flow quantity condition or the packet reception error quantity condition, a priority gateway can be switched if line quality of a route of a priority gateway is degraded.

The specified packet reception is a state where a specified packet is received. The specified packet is a multicast packet from gateways other than a priority gateway, or a unicast packet from a gateway other than a priority gateway. The multicast packet from gateways other than a priority gateway is NS (Neighbor Solicitation, an address resolution request). The NS packet referred to here is, for example, a packet transmitted, for example, when the server 12x desires to communicate with the terminal 14x, and this is a packet where an IP address of the terminal 14x and a gateway (a non-priority gateway in this case) via which a packet is to pass are specified. The unicast packet from a gateway other than a priority gateway is a packet for which address resolution has been made and which is transmitted from the server 12x via a non-priority gateway to the terminal 14x.

If the specified packet reception condition is satisfied, this is considered as a case where the server 12x requests a communication via a non-priority gateway because the server 12x cannot make a communication via a priority gateway.

If the specified packet reception condition is satisfied, the L2 monitoring processing unit 42 transmits, to the L3 processing unit 23, the gateway switching instruction to switch to a non-priority gateway that has relayed the specified packet as a new priority gateway. The L3 processing unit 23 that has received the gateway switching instruction with the NS packet transmits a response with an NS packet after switching the priority gateway.

With the specified packet reception condition, when transmitting a packet to the terminal 14x via a non-priority gateway, the server 12x can switch the gateway as a priority gateway with the above described terminal management process.

The monitoring information and the gateway switching condition when the network interface 53 is a wireless port are described below.

The monitoring information when the network interface 53 is a wireless port includes reception radiowave intensity in addition to the monitoring information used when the network interface 53 is a wired port.

The reception radiowave intensity is obtained from the network interface 53, and is stored for each transmission source MAC address. The reception radiowave intensity condition that is the gateway switching condition for the reception radiowave intensity is that the reception radiowave intensity of a non-priority gateway becomes higher than that of a priority gateway. Note that the reception radiowave intensity condition may be a condition that (reception radiowave intensity of a non-priority gateway—reception radiowave intensity of a priority gateway) becomes larger than a predetermined margin.

If the reception radiowave intensity condition is satisfied, this is considered as a case where line quality via a corresponding non-priority gateway becomes higher than that via a priority gateway.

If the reception radiowave intensity condition is satisfied, the L2 monitoring processing unit 42 transmits, to the L3 processing unit 23, the gateway switching instruction to switch to a non-priority gateway for which the reception radiowave intensity condition has been satisfied as a new priority gateway.

With the reception radiowave intensity condition, a route having high wireless line quality can be used even when wireless line quality changes due to a move or the like of the terminal 14x.

The L2 monitoring processing unit 42 may obtain a MAC address of a priority gateway and a MAC address of a non-priority gateway, and other items of information among monitoring information by referencing route information stored in the route information storing unit 24.

With the above described L2 monitoring process, route switching based on L2 information can cope with a change of a line state faster than route switching based on L3 information.

According to this embodiment, route control can be performed according to a line state by switching a gateway based on L2 information. As a result, switching can be made to a route where a line state is stable before a communication becomes impossible between the terminal 14x and the server 12x. As a result, a communication interrupt can be prevented from occurring. Moreover, even though a gateway suspends, the length of time needed until the determination of the second L3 route control process is shorter than the length of time needed until the determination of the first L3 route control process.

Additionally, the server 12x can communicate with the terminal 14x via a non-priority gateway. Moreover, even though an L2 line cannot be recognized such as in a case where a communication becomes impossible between GW1 and the server 12x, the terminal 14x can switch to GW2 by using the arrival of a packet from GW2 as a trigger. Therefore, switching can be made faster than the first L3 route control process. Moreover, the server 12x can learn an address assigned to a terminal based on the terminal management table. In addition, the terminal 14x can collaborate with various types of servers (DNS or the like) used for maintenance. For example, a DNS server can perform suitable terminal management by properly linking a domain and an IP address of a communicative terminal.

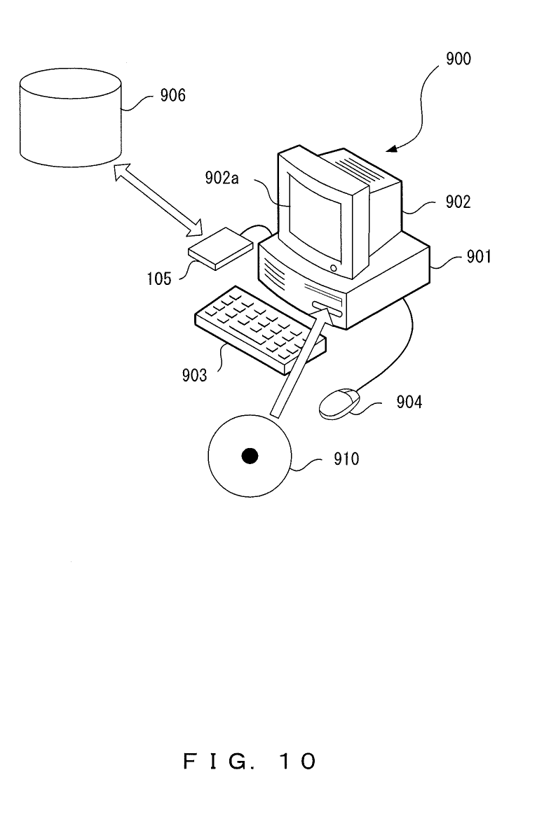

The present invention is applicable to a computer system described below. FIG. 10 illustrates one example of the computer system to which the present invention is applied. The computer system 900 illustrated in this figure includes a main body unit 901 including a CPU, a disk drive and the like, a display 902 for displaying an image according to an instruction from the main body unit 901, a keyboard 903 for inputting various items of information to the computer system 900, a mouse 904 for specifying an arbitrary position on a display screen 902a of the display 902, and a communication device 905 for downloading a program or the like stored in another computer system by accessing an external database or the like. The communication device 905 is, for example, a network communication card, a modem or the like.

A program for causing the above described computer system configuring the communication apparatus to execute the above described steps can be provided as a communication program. This program is stored onto a recording medium that can be read by the computer system, whereby the computer system configuring the communication apparatus can be made to execute this program. The program for executing the above described steps is stored onto a portable recording medium such as a disk 910 or the like, or downloaded from a recording medium 906 of another computer system by the communication device 905. Moreover, the communication program for providing the computer system 900 with at least a communication function is input to the computer system 900, which then compiles the program. This program causes the computer system 900 to operate as a communication system having a communication function. Additionally, this program may be stored onto a computer-readable recording medium such as the disk 910 or the like. Here, examples of the recording medium that can be read by the computer system 900 include an internal storage device, such as a ROM, a RAM or the like, included in the computer, a portable storage medium such as the disk 910, a flexible disk, a DVD disk, a magneto-optical disk, an IC card or the like, a database holding a computer program, or a database of another computer system, and various types of recording media accessible by a computer system connected via communication means such as the communication device 905.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

### FIG. 2

52. STORING UNIT
53. NETWORK INTERFACE
GATEWAY

### FIG. 3

23. L3 PROCESSING UNIT
31. L3 ROUTE CONTROLLING UNIT
32. RA REQUEST PROCESSING UNIT
33. RA RECEPTION PROCESSING UNIT
34. SERVER COLLABORATION PROCESSING UNIT
22. L2 PROCESSING UNIT
41. L2 COMMUNICATION CONTROLLING UNIT
42. L2 MONITORING PROCESSING UNIT
24. ROUTE INFORMATION STORING UNIT
25. MONITORING INFORMATION STORING UNIT

### FIG. 4

DEFAULT ROUTER LIST
GATEWAY
VALIDITY PERIOD
RA TRANSMISSION SOURCE MAC ADDRESS
PREFIX LIST
PREFIX/LENGTH
GATEWAY
VALIDITY PERIOD
RA TRANSMISSION SOURCE MAC ADDRESS
ROUTING TABLE
DESTINATION NETWORK
GATEWAY
DEFAULT ROUTE
ADDRESS MANAGEMENT TABLE
MAC ADDRESS
GATEWAY
GLOBAL ADDRESS
PRIORITY
NON-PRIORITY

### FIG. 5

START
S11. OBTAINING PRIORITY MAC ADDRESS
S12. IS PRIORITY MAC ADDRESS ALREADY REGISTERED TO DEFAULT ROUTER LIST?
S13. SETTING PRIORITY GATEWAY
S14. IS PRIORITY MAC ADDRESS ALREADY REGISTERED TO PREFIX LIST?
S15. SETTING GLOBAL ADDRESS
S16. SETTING ADDRESS MANAGEMENT TABLE
S17. IS PRIORITY MAC ADDRESS UNREGISTERED TO ADDRESS MANAGEMENT TABLE?
S18. STARTING RA REQUEST PROCESS
END

### FIG. 6

START
S21. IS PRIORITY MAC ADDRESS UNREGISTERED TO ADDRESS MANAGEMENT TABLE?
S22. TRANSMITTING RS AFTER TRANSMISSION TIME INTERVAL ELAPSES
END

### FIG. 7

START
S31. OBTAINING RA
S32. ADDING ENTRY TO DEFAULT ROUTER LIST
S33. ADDING ENTRY TO PREFIX LIST
END

### FIG. 8

START
S61. GENERATING GATEWAY UPDATE NOTIFICATION
S62. TRANSMITTING GATEWAY UPDATE NOTIFICATION
END

### FIG. 9

START
S41. ACTIVATING LINE
S42. DEACTIVATING LINE?
S43 (S44?)
   DEACTIVATING LINE
END
S44 (S45?)
   GATEWAY REGISTRATION INSTRUCTION
S51. PERIODICAL MONITORING TIME?
S52. OBTAINING MONITORING INFORMATION
S53. IS GATEWAY DELETION CONDITION SATISFIED?
S54. GATEWAY DELETION INSTRUCTION
S55. IS GATEWAY SWITCHING CONDITION SATISFIED?
S56. GATEWAY SWITCHING INSTRUCTION

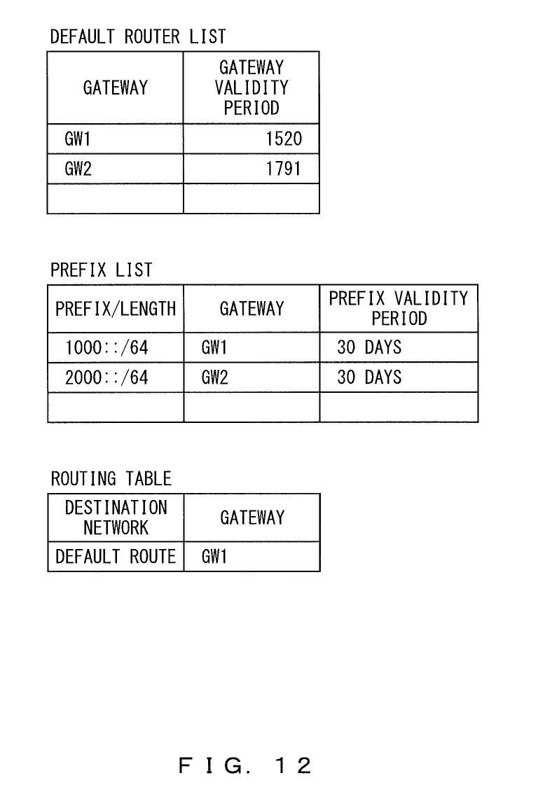

### FIG. 12

DEFAULT ROUTER LIST
GATEWAY
GATEWAY VALIDITY PERIOD
PREFIX LIST
PREFIX/LENGTH
GATEWAY
PREFIX VALIDITY PERIOD
ROUTING TABLE
DESTINATION NETWORK
GATEWAY
DEFAULT ROUTE

What is claimed is:

1. A communication apparatus that can communicate with a network, comprising:
a transmitting/receiving unit configured to transmit a packet to the network and to receive a packet from the network;
a first information storing unit configured to store first information about a route between the transmitting/receiving unit and the network;
a second information storing unit configured to store second information that specifies a gateway, via which a packet transmitted from the transmitting/receiving unit to the network is to pass, from among the first information stored in the first information storing unit;
a detecting unit configured to detect third information including Layer 2 information about a gateway indicated by a received packet based on the packet received by the transmitting/receiving unit;
a determining unit configured to determine whether or not a first condition that is a condition for a change of the second information is satisfied based on the third information detected by the detecting unit; and
a changing unit configured to change the gateway specified in the second information stored in the second information storing unit if the determining unit determines that the first condition is satisfied.

2. The communication apparatus according to claim 1, further comprising
a setting unit configured to set the gateway specified in the second information as a route of the packet transmitted from the transmitting/receiving unit to the network based on the first information stored in the first information storing unit and the second information stored in the second information storing unit.

3. The communication apparatus according to claim 1, wherein
the third information includes at least any of measured values of a reception packet quantity from a target gateway in the third information and a reception error packet quantity from the gateway.

4. The communication apparatus according to claim 3, wherein
the first condition is that the measured value in the third information of the gateway specified in the second information is outside a predetermined range.

5. The communication apparatus according to claim 1, wherein
the third information includes a state of reception of a packet from a gateway other than the gateway specified in the second information.

6. The communication apparatus according to claim 5, wherein
the first condition is that the packet from the gateway other than the gateway specified in the second information is received.

7. The communication apparatus according to claim 1, wherein
the transmitting/receiving unit wirelessly transmits a packet to the network, and wirelessly receives a packet from the network, and
the third information includes a reception radiowave intensity of a packet received from a target gateway in the third information.

8. The communication apparatus according to claim 7, wherein
the determining unit makes a comparison between a first reception radiowave intensity that is the reception radiowave intensity in the third information of the gateway specified in the second information and a second reception radiowave intensity that is the reception radiowave intensity in the third information of a gateway different from the gateway, and
the first condition is that (the second reception radiowave intensity—the first reception radiowave intensity) becomes larger than a predetermined margin.

9. The communication apparatus according to claim 1, wherein
the determining unit determines whether or not the second condition that is a first information deletion condition of a gateway is satisfied based on third information of the gateway, and
the first condition is that the second condition of the gateway specified in the first information is satisfied.

10. The communication apparatus according to claim 9, wherein
the third information includes a time during which a packet from a target gateway in the third information is not received, and
the second condition is that the time becomes longer than a predetermined time threshold value.

11. The communication apparatus according to claim 1, wherein
the changing unit transmits a request of the first information of the gateway if the gateway specified in the second information after being changed is not included in the first information stored in the first information storing unit.

12. The communication apparatus according to claim 2, wherein
if at least any of the first information and the second information is updated, the setting unit transmits a notification of the update to a predetermined management device in the network.

13. The communication apparatus according to claim 1, wherein
the first information includes information of Layer 3 and a MAC address of a gateway.

14. The communication apparatus according to claim 1, wherein
the second information includes an identifier of a gateway.

15. The communication apparatus according to claim 1, wherein
the detecting unit periodically detects the second information.

16. A computer-readable non-transitory medium on which a communication program for causing a computer of a communication apparatus that can communicate with a network to control the communication apparatus, the communication program comprising:
causing a first information storing unit of the communication apparatus to store first information about a route between the communication apparatus and the network;
causing a second information storing unit of the communication apparatus to store second information that specifies a gateway, via which a packet transmitted from the communication apparatus to the network is to pass, from among the first information stored in the first information storing unit;
detecting third information including Layer 2 information about a gateway indicated by a received packet based on the packet received by the communication apparatus;
determining whether or not a first condition that is a condition for a change of the second information is satisfied based on the detected third information; and
changing the gateway specified in the second information stored in the second information storing unit if it is determined that the first condition is satisfied.

17. The medium according to claim 16, the communication program further comprising
setting the gateway specified in the second information as a route of the packet transmitted from the communication apparatus to the network based on the first information stored in the first information storing unit and the second information stored in the second information storing unit.

18. The medium according to claim 16, wherein
the third information includes at least any of measured values of a reception packet quantity from a target gateway in the third information and a reception error packet quantity from the gateway.

19. The medium according to claim 18, wherein
the first condition is that the measured value in the third information of the gateway specified in the second information is outside a predetermined range.

20. A communication method for controlling a communication apparatus that can communicate with a network, comprising:
causing a first information storing unit of the communication apparatus to store first information about a route between the communication apparatus and the network;
causing a second information storing unit of the communication apparatus to store second information that specifies a gateway, via which a packet transmitted from the communication apparatus to the network is to pass, from among the first information stored in the first information storing unit;
detecting third information including Layer 2 information about a gateway indicated by a received packet based on the packet received by the communication apparatus;
determining whether or not a first condition that is a condition for a change of the second information is satisfied based on the detected third information; and
changing the gateway specified in the second information stored in the second information storing unit if it is determined that the first condition is satisfied.
